(19) United States
(12) Patent Application Publication
(10) Pub. No.: US 2017/0091687 A1
(43) Pub. Date: Mar. 30, 2017

(54) SYSTEM AND METHOD FOR BIDDING ON WORK PROJECTS

(71) Applicant: Christopher Adam Gates, Cary, NC (US)

(72) Inventor: Christopher Adam Gates, Cary, NC (US)

(21) Appl. No.: 15/189,657

(22) Filed: Jun. 22, 2016

Related U.S. Application Data
(60) Provisional application No. 62/232,747, filed on Sep. 25, 2015.

(51) Int. Cl. G06Q 10/06

(52) U.S. Cl. CPC G06Q 10/06313

(57) ABSTRACT

A method of completing work projects within a company is provided. The steps include posting information about a project by a project requestor. Project managers place bids on the project and are accepted by the project requestor to perform the project. The project managers then post information about tasks required to complete the project. Project workers bid on the individual tasks and are accepted by the project manager. The tasks are then completed by the project workers and consolidated by the project managers. The completed project is provided to the project requestor and the project requestor provides the completed project to a client of the company.

### CROSS-REFERENCE TO RELATED APPLICATION

This application claims the benefit of priority of U.S. provisional application No. 62/232,747, filed Sep. 25, 2015, the contents of which are herein incorporated by reference.

### BACKGROUND OF THE INVENTION

The present invention relates to a system and method for bidding on work projects.

Companies are currently organized in a military hierarchical fashion where workers are given work in a command style fashion. This is very similar to how communist nations are organized. Most businesses internal organization structure is based on a command economy. As can be seen, there is a need for an improved working method for companies

### SUMMARY OF THE INVENTION

In one aspect of the present invention, a method of completing work projects within a company comprises the steps of: posting information about a project by a project requestor on a first bidding platform via software running on a computer, wherein the first bidding platform is viewable by a plurality of project managers; placing at least one bid on the first bidding platform by one of the project managers for the project via software running on the computer; accepting the at least one bid of the project manager by the project requestor for the project via software running on the computer; posting a plurality of tasks of the project by the project manager on a second bidding platform via software running on a computer, wherein the second bidding platform is viewable by a plurality of project workers; placing at least one bid on the second bidding platform by one of the project workers for at least one of the plurality of tasks via software running on the computer; and accepting the at least one bid of the project worker via software running on the computer.

In another aspect of the present invention, a system for completing work projects within a company comprises: at least a first computer comprising a memory, a processor and a user interface, wherein the processor produces a first bidding platform comprising a project posted by a project requestor; receives a plurality of bids from a plurality of project managers, wherein the plurality of bids are displayed via the user interface to the project requestor and one of the plurality of bids from the plurality of project managers is selected by the project requestor; produces a second bidding platform comprising a plurality of tasks of the project posted by the selected project manager; and receives a plurality of bids from a plurality of project workers, wherein the plurality of bids are displayed via the user interface to the selected project manager and at least one of the plurality of bids from the plurality of project workers is selected by the selected project manager.

These and other features, aspects and advantages of the present invention may become better understood with reference to the following drawings, description and claims.

### BRIEF DESCRIPTION OF THE DRAWINGS

FIG. 1 is a schematic view of an embodiment of the present invention;

FIG. 2 is a flow chart of an embodiment of the present invention; and

FIG. 3 is a continuation of the flow chart of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention creates a competitive bidding system marketplace that aids in project management for work within large companies. The present invention includes a software that organizes work flow through a business. The software uses a ‘supply and demand’ marketplace approach to increase efficiency. The software creates price and information signals within the business, so that workers can bid on work in a supply and demand fashion consistent with a market place. This allows workers to bid on projects and managers to select the lowest priced bidder for work. This increases efficiency by using free-market supply and demand principles that have been validated in capitalist economies. The software enables a ‘market place’ approach to work flow instead of a military command style economy.

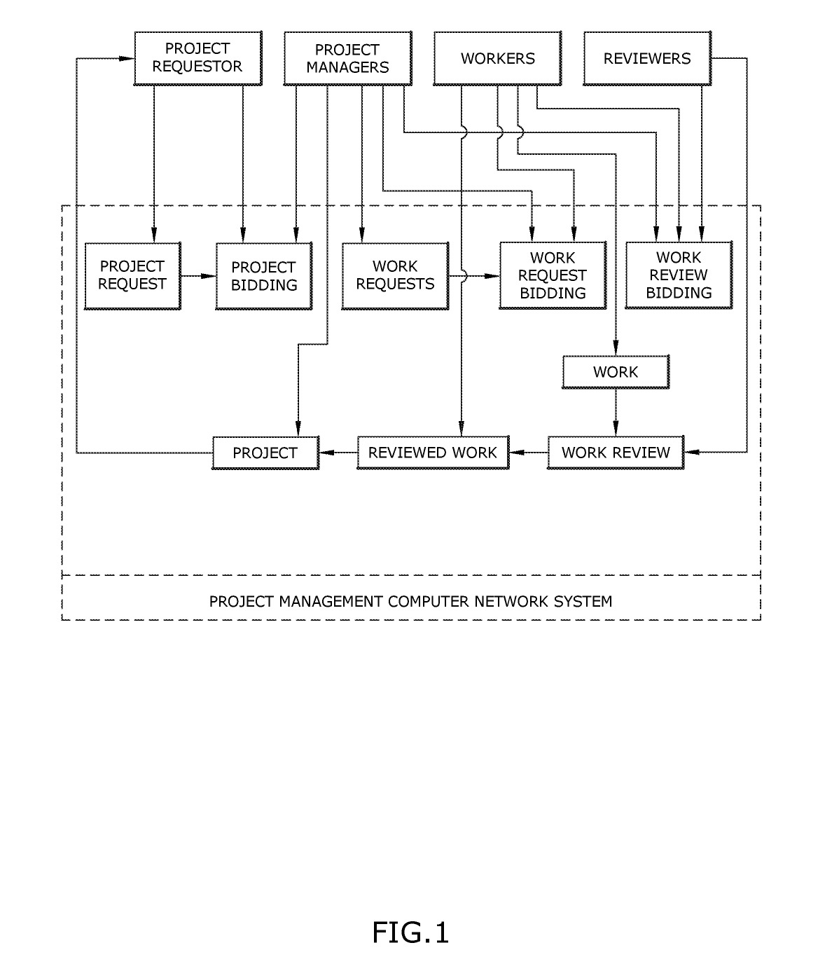

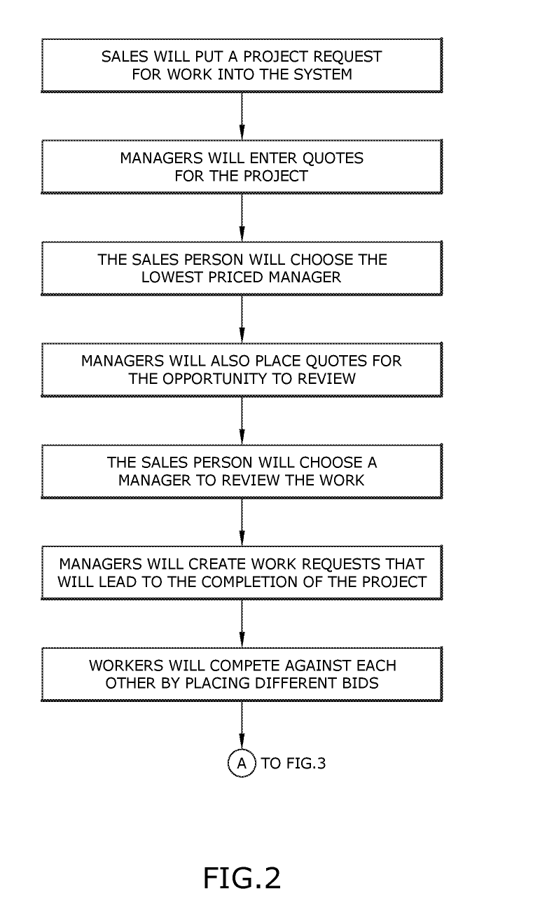

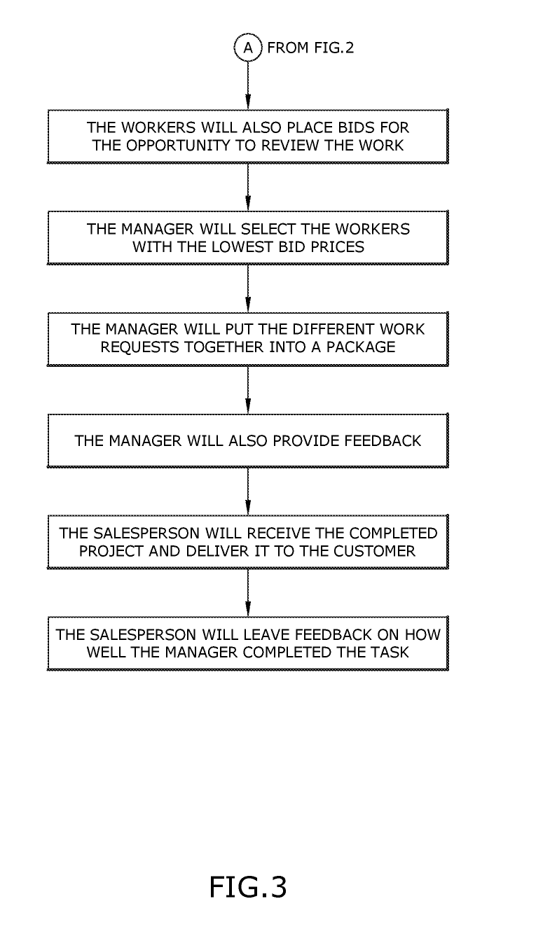

Referring to FIGS. 1 through 3, the present invention may include the following steps:
1. Sales (project requestor) place a project request for work into the system (a first bidding platform).
2. Project managers bid on the projects by entering quotes for the project on how much they expect to be rewarded for their work.
3. The sales person (project requestor) chooses the lowest priced project manager or the manager who provides the best price for their reputation of providing quality work or level of expertise.
4. Project managers also place quotes for the opportunity to review the work of the other manager.
5. The sales person (project requestor) chooses a second project manager to review the work of a first project manger completing the work. The sales person (project requestor) chooses the reviewer based on their expected price and quality of their work.
6. Project managers create work requests that lead to the completion of the project (plurality of tasks for completion of the project) and post them on a second bidding platform.
7. Project workers compete against each other by placing different bids on the different work requests. The project workers provide a quote for how much they expect to receive in compensation for their work effort.
8. The project workers also place bids for the opportunity to review the work requests completed by other project workers. The bid may be the compensation they expect to receive for their work.
9. The project manager selects the workers with the lowest bid prices or the workers who provides the best price for their reputation of providing quality work or level of expertise.
10. The project manager places the different work requests together into a package and delivers it to sales (project requestor).
11.The project manager may also provide feedback on the work requests submitted to each of the workers. This increases accountability within the system.
12. The sales person (project requestor) receives the completed project and delivers it to the customer.
13. The sales person (project requestor) may leave feedback on how well the project manager completed his/her job to provide accountability within the system.

Sales place project requests into the system for managers to bid and then work on. Managers may place bids for how much they expect to be compensated for managing a project. Managers may be competing for the opportunity to work which may improve productivity. Managers may also place bids for the compensation they expect to receive to review another manager's work. Managers may review each other's work to ensure quality and accountability. Sales may also provide feedback on the work the manager did to ensure accountability. Managers may input work requests into the system. The work requests may need to be completed to ensure that the project gets completed. Workers may bid for the work requests where their bids may be the compensation they expect to receive for their work. Workers may also compete for the opportunity to review each other's work to ensure accountability and work quality. Managers may also leave feedback on workers to ensure accountability and work quality.

In certain embodiments, the present invention may include a qualification system whereby workers may be qualified for various tasks. They can be: experts, workers, or apprentices. Experts are allowed to review work and complete assignments. Workers complete assignments but cannot review work. Apprentices complete assignments but are under the tutelage of an expert. Apprentices may be given a training budget which they can pay an expert to teach them. When the apprentice is promoted to a worker, it is noted within the system who trained them to ensure accountability.

In certain embodiments, the present invention may further include an operations and strategy department that creates work orders for the system itself where the work orders increase efficiency. Various managers may bid for the opportunity to manage these ‘efficiency projects.’ These managers may ensure that the systems information, deliverables, and price signals all function to produce efficient results. The system itself measures and stores work in a database so that analytics can be conducted on the work flow.

The manager and workers may receive their compensation in the form of electronic points, dollars, or some other form of compensation. The goal with the compensation system is to provide real money that can be spent. The compensation could also be electronic points that could be redeemable for time off work or raises at the end of the year. The compensation received is any type of measurement system that can be used to gauge work effort and provide rewards to employees for the work they complete.

A method of using the present invention may include the following. The users of the system and method have access to a computer running the software. If they are a sale person or other work requestor they would input their information into the system. The sales person further makes a post including detailed information about a project that needs to be completed for a client. Then other users may bid on the opportunity to work on the project. The work requester may select the bidder with the best value. Once the worker is done, their work is reviewed and sent to the work requester. Then the work requester provides feedback on the quality of work they produced. For a worker, they would receive assignments through the system when they are qualified. The worker would then place a bid on how much compensation they expect to receive for the work. After a few bids are placed in the system, the worker can lower their bid price if they want. The worker may then be selected by the work requester if they are the best value or preferred selection. The worker may then complete the work, before letting another worker review the work. The reviewer may provide recommendations and the worker may fix the problems. Then the worker may submit the work to the requester. The requester provides feedback on the work and releases compensation to the employee. The system may require something similar to a currency to function. The currency could be actual money, or it could be an ‘electronic point’ system. The electronic points can be used as a reward for employees where more electronic points lead to monetary compensation, higher raises, or time off from work.

In alternate embodiments, instead of using the system to complete sales requests or projects, the system could be used to complete any type of task. The system could be used to institute research and development projects. The system could be used to conduct operations, marketing, or efficiency improvement projects. The system could be used to manage government bureaucracies and agencies. The system could be used to organize non-profit work. The system could be used to organize high school athletes so that they complete a certain amount of training per week. The system could be used to complete any project where groups of people are working together. The present invention includes a marketplace based project management software system.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of completing work projects within a company comprising the steps of:
posting information about a project by a project requestor on a first bidding platform via software running on a computer, wherein the first bidding platform is viewable by a plurality of project managers;
placing at least one bid on the first bidding platform by one of the project managers for the project via software running on the computer;
accepting the at least one bid of the project manager by the project requestor for the project via software running on the computer;
posting a plurality of tasks of the project by the project manager on a second bidding platform via software running on a computer, wherein the second bidding platform is viewable by a plurality of project workers;
placing at least one bid on the second bidding platform by one of the project workers for at least one of the plurality of tasks via software running on the computer; and
accepting the at least one bid of the project worker via software running on the computer.

2. The method of claim 1, wherein a plurality of bids are placed on the first bidding platform, wherein the project requestor accepts one of the plurality of bids via software running on the computer.

3. The method of claim 1, wherein the bids comprise a monetary value.

4. The method of claim 1, further comprising the steps of:
posting a project review request on the first bidding platform by the project requestor via software running on a computer;
placing at least one bid on the first bidding platform by one of the project managers for the project review request via software running on the computer; and
accepting the at least one bid of the project manager by the project requestor for the project review via software running on the computer.

5. The method of claim 1, further comprising the steps of:
completing the plurality of tasks by at least one of the project workers; and
delivering a completed project to the project requestor by the project manager.

6. A system for completing work projects within a company comprising:
at least a first computer comprising a memory, a processor and a user interface, wherein the processor:
produces a first bidding platform comprising a project posted by a project requestor;
receives a plurality of bids from a plurality of project managers, wherein the plurality of bids are displayed via the user interface to the project requestor and one of the plurality of bids from the plurality of project managers is selected by the project requestor;
produces a second bidding platform comprising a plurality of tasks of the project posted by the selected project manager; and
receives a plurality of bids from a plurality of project workers, wherein the plurality of bids are displayed via the user interface to the selected project manager and at least one of the plurality of bids from the plurality of project workers is selected by the selected project manager.

7. The system of claim 6, wherein the bids comprise a monetary value.

8. The system of claim 6, wherein the project requestor posts a project review request on the first bidding platform.

9. The system of claim 8, wherein the processor
receives a plurality of bids from a plurality of managers for the project review request, wherein the plurality of bids are displayed via the user interface to the project requestor and at least one of the plurality of bids from the plurality of project managers is selected by the project requestor.
